(19) United States
(12) Patent Application Publication
(10) Pub. No.: US 2010/0164988 A1
(43) Pub. Date: Jul. 1, 2010

(54) Image Display Device and Image Display Method

(75) Inventor: Toshiyasu Tamura, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/473,145

(22) Filed: May 27, 2009

(30) Foreign Application Priority Data
Dec. 25, 2008 (JP) 2008-331502

(51) Int. Cl. G09G 5/00

(52) U.S. Cl. 345/629

(57) ABSTRACT

An image display device is provided with an image input unit configured to receive an image; an image quality setting unit configured to apply a plurality of image quality settings different from one another to the image received by the image input unit for obtaining a plurality of images whose image quality is different; an image composition unit configured to generate a composite image including the plural images whose image quality is different obtained in the image quality setting unit arranged as a plurality of image quality comparison images; and an image display unit configured to display the composite image generated in the image composition unit thereon.

### CROSS-REFERENCE TO RELATED APPLICATION

This application is based upon and claims the benefit of priority from the prior Japanese Patent Application No. 2008-331502, filed on Dec. 25, 2008; the entire contents of which are incorporated herein by reference.

### BACKGROUND

1. Field of the Invention

The present invention relates to an image display device displaying an image thereon and an image display method.

2. Description of the Related Art

There has been known a television receiver displaying a video on which a video control function is in an on state (a video on which a specific image quality adjustment is performed) on one divided screen, which is made by dividing a display screen in two, and displaying a video on which the video control function is in an off state (a video on which the specific image quality adjustment is not performed) on the other divided screen (refer to, for example, JP-B2 3179462).

That is, the television receiver disclosed in the above-described document can simultaneously display the video on which the video control function is validated and the video on which the video control function is invalidated thereon without switching display of a screen thereof. Accordingly, the above-described television receiver allows a user to comprehend the effect of the video control function easily.

### SUMMARY

Such a conventional apparatus has a problem in the case when specific image quality settings of, for example, two kinds or more are previously registered therein, and further, the effects of these image quality settings are desired to be compared with one another, or the like.

That is, the above-described conventional apparatus is to display a video on which a specific image quality of one kind is set and a video on which the image quality is not set thereon. Therefore, the above-described conventional apparatus does not allow two videos on which specific image quality settings of, for example, two kinds are performed individually to be visually compared simultaneously.

Here, the present invention is made to solve the above-described problem, and has an object to provide an image display device allowing a desired image quality setting to be discerned easily and an image display method.

An image display device according to one aspect of the present invention is provided with an image input unit configured to receive an image; an image quality setting unit configured to apply a plurality of image quality settings different from one another to the image received by the image input unit for obtaining a plurality of images whose image quality is different; an image composition unit configured to generate a composite image including the plural images whose image quality is different obtained in the image quality setting unit arranged as a plurality of image quality comparison images; and an image display unit configured to display the composite image generated in the image composition unit thereon.

An image display method according to one aspect of the present invention includes: receiving an image; applying a plurality of image quality settings different from one another to the received image for obtaining a plurality of images whose image quality is different; generating a composite image including the plural images whose image quality is different are arranged as a plurality of image quality comparison images; and displaying the generated composite image.

### BRIEF DESCRIPTION OF THE DRAWINGS

FIG. 1 is a block diagram functionally showing a structure of a television receiving apparatus in which an image display device according to one embodiment of the present invention is mounted.

FIG. 2 is a block diagram functionally showing a configuration of an image processing device provided in the image display device in FIG. 1.

FIG. 3 is a view showing contents of an image quality setting table provided in the image display device in FIG. 1.

FIG. 4 is a view showing an image quality comparison display execution menu displayed by the image display device in FIG. 1.

FIG. 5 is a view showing an image quality comparison screen displayed by the image display device in FIG. 1.

FIG. 6 is a view showing a hierarchical structure of a function setting menu displayed by the image display device in FIG. 1.

FIG. 7 is a flowchart showing processing for realizing an image quality comparison display performed by the image display device in FIG. 1.

### DETAILED DESCRIPTION

Hereinafter, an embodiment of the present invention will be explained in details based on the drawings.

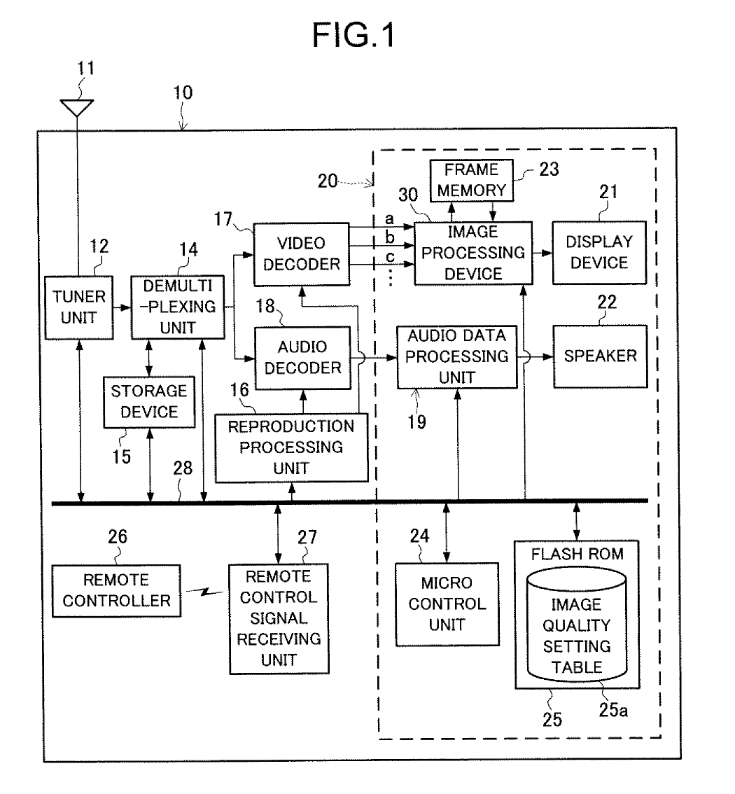

As shown in FIG. 1, a television receiving apparatus 10 in which an image display device 20 according to this embodiment is mounted is a digital television receiving apparatus including, for example, a recording function. The television receiving apparatus 10 is provided with an antenna 11, a tuner unit 12, a demultiplexing unit 14, a storage device 15, a reproduction processing unit 16, a video decoder 17, an audio decoder 18, a bus 28, a remote controller 26, and a remote control signal receiving unit 27.

The image display device 20 mounted in the television receiving apparatus 10 is provided with an image processing device 30, a frame memory 23, a display device 21 such as a liquid crystal display, an audio data processing unit 19, a speaker 22, a flash ROM (an EEPROM) 25, and a micro control unit 24 controlling each of the units in an integrated manner.

The remote controller 26 is provided with various operation buttons in order that a user performs an input operation. The remote control signal receiving unit 27 is an interface unit with the remote controller 26. The tuner unit 12 selects a desired broadcast wave (a broadcast station) from, for example, digital broadcast waves led from the antenna 11 respectively. Note that a broadcast signal for a digital broadcast may be led from not only an antenna but also a cable television station or the like through a cable.

The demultiplexing unit 14 demultiplexes each of a video signal and an audio signal being multiplexed in the broadcast wave to output them to the video decoder 17 and the audio decoder 18 respectively. The reproduction processing unit 16 controls the video decoder 17 and the audio decoder 18, and reproduces (decodes) contents demultiplexed in the demultiplexing unit 14.

The video decoder 17 decodes the video signal demultiplexed in the demultiplexing unit 14, and outputs a decoded digital video signal to the image processing device 30. On the other hand, the audio decoder 18 decodes the audio signal demultiplexed in the demultiplexing unit 14, and outputs a decoded digital audio signal to the audio data processing unit 19.

The storage device 15 is provided with, for example, a hard disc drive device and an optical disc drive device capable of writing in a recordable optical disc, and the like. The storage device 15 can save contents such as a received broadcast program, which are yet to be decoded in the video decoder 17 and the audio decoder 18 therein. Note that the storage device 15 may be an external storage device such as a DVD recorder or an external HDD, or an internal storage device such as a built-in HDD or a flash memory.

The image processing device 30 and the audio data processing unit 19 perform predetermined audio processing and image processing for the decoded digital video signal and digital audio signal. Further, the image processing device 30 and the audio data processing unit 19 output the processed video signal and audio signal to the display device 21 and the speaker 22 respectively.

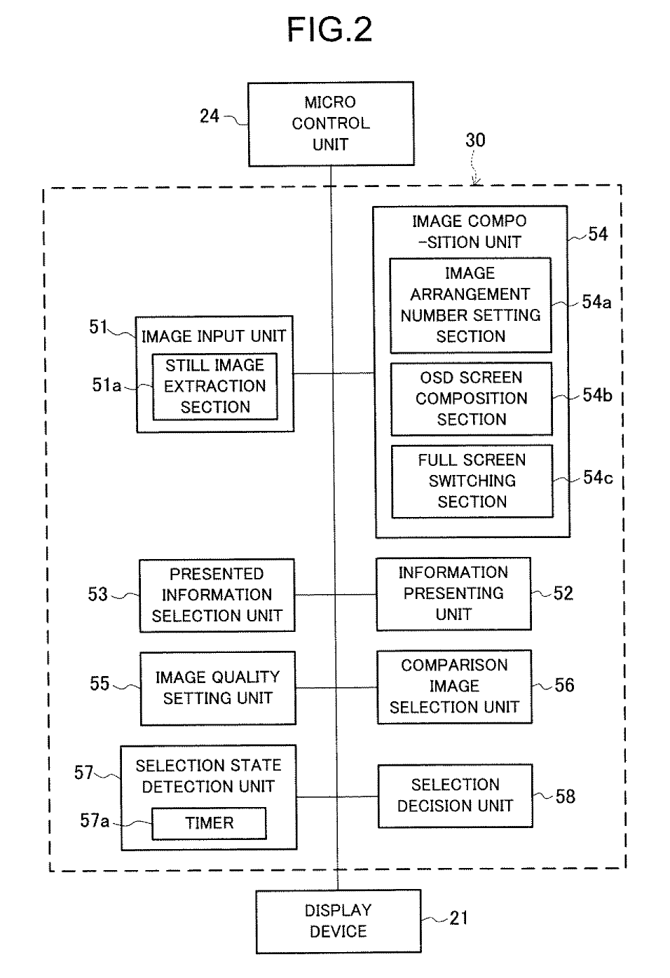

Next, the configuration of the image processing device 30 will be described in details based on FIG. 2 to FIG. 6, in addition to FIG. 1. The image processing device 30 is a main component for realizing a later-described image quality comparison display. As shown in FIG. 2, the image processing device 30 is provided with an image input unit 51, an information presenting unit 52, a presented information selection unit 53, an image composition unit 54, an image quality setting unit 55, a comparison image selection unit 56, a selection state detection unit 57, and a selection decision unit 58.

The image input unit 51, as shown in FIG. 1, FIG. 2, receives images (a source a, b, c . . . ) output from the video decoder 17. Here, the source of image received by the image input unit 51 represents classification of image data indicating that the image data is the data stored in the storage device 15, or the image data is the data obtained by receiving a broadcast wave directly, or the like. Further, the image input unit 51 is provided with a still image extraction section 51a. The still image extraction section 51a detects whether the received image is a moving image or a still image. The still image extraction section 51a extracts one scene from the image received by the image input unit 51 as a still image, when the image received by the image input unit 51 is a moving image.

The image quality setting unit 55 applies a plurality of image quality settings different from one another to the image received by the image input unit 51 for obtaining a plurality of images whose image quality is different. Further, the image quality setting unit 55, as shown in FIG. 1 to FIG. 3, generates a plurality of images whose image quality is different as a still image with reference to an image quality setting table 25a stored beforehand in the flash ROM (EEPROM) 25.

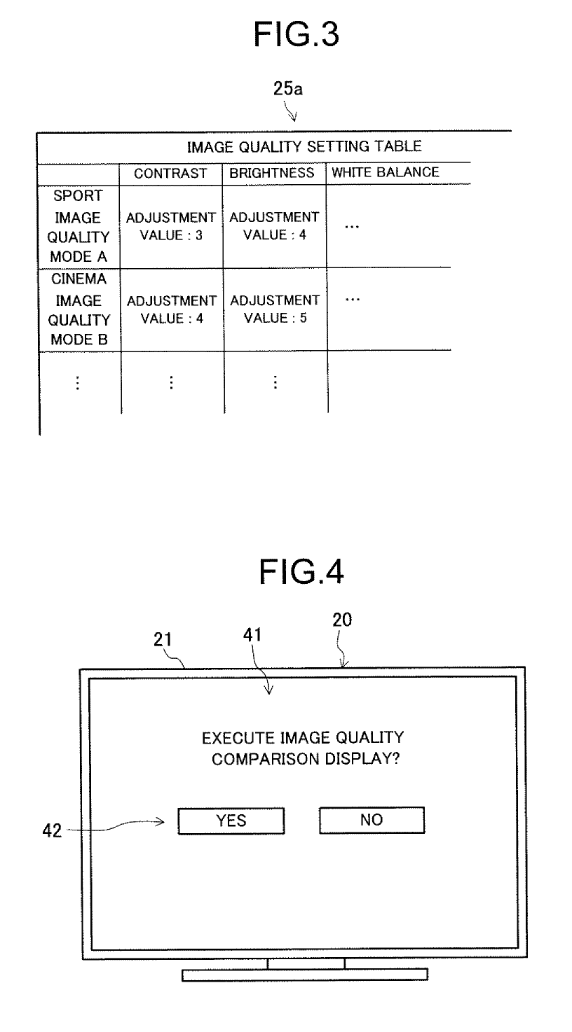

The image quality setting table 25a, as shown in FIG. 3, stores image quality settings of at least six kinds or more such as, for example, a sport, a cinema, standard, and dynamic . . . as image quality modes A to F . . . therein. Further, the image quality setting table 25a correspondingly stores adjustment values of each parameter such as contrast, brightness, white balance, and sharpness . . . in each of these image quality modes A to F . . . therein.

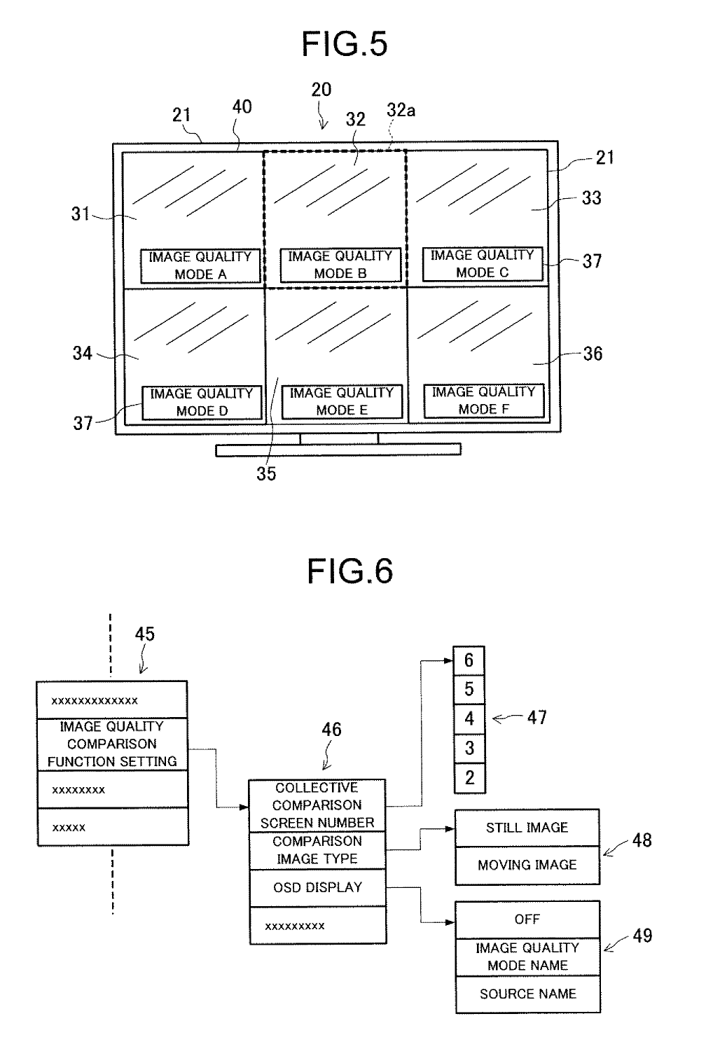

As shown in FIG. 1, FIG. 2, and FIG. 5, a composite image 40 is generated while making use of the frame memory 23. That is, the image composition unit 54 arranges the plural images whose image quality is different obtained in the image quality setting unit 55 as a plurality of image quality comparison images 31 to 36 thereby generating the composite image 40.

Further, as shown in FIG. 2, FIG. 5, the display device 21 functioning as an image display unit displays the composite image 40 composed of the plural image quality comparison images 31 to 36 generated in the image composite unit 54 thereon. Specifically, the display device 21 displays the composite image (a multi-screen) 40 on which the six image quality comparison images 31 to 36 where the image quality modes A to F are set individually are arranged as a sub-screen (a divided screen) thereon.

As shown in FIG. 2, FIG. 4, the information presenting unit 52 controls the display device 21 to display execution instruction information 42 for instructing execution of the image quality comparison display to the image quality setting unit 55, the image composition unit 54 and the display device 21 in a selectable manner. Here, the execution instruction information 42 is information to execute each of an application of the plural image quality settings performed in the image quality setting unit 55, a generation of the composite image 40 performed in the image composition unit 54 and a display of the composite image 40 performed in the display device 21. Further, the image quality comparison display is a display mode which the image quality setting unit 55, the image composition unit 54, and the display device 21 perform cooperatively and on which the composite image 40 composed of the above-described plural image quality comparison images 31 to 36 is displayed.

Concretely, in the case when the micro control unit 24 accepts a presenting request of an image quality comparison display execution menu 41, the information presenting unit 52, as shown in FIG. 4, displays the image quality comparison display execution menu 41 including the execution instruction information 42 on the display device 21. The presenting request of the image quality comparison display execution menu 41 is realized by, for example, a predetermined button operation by the remote controller 26 (or a predetermined button operation on a main body of the television receiving apparatus 10).

As shown in FIG. 2, FIG. 4, the presented information selection unit 53 can select the execution instruction information 42 displayed by the display device 21. That is, the presented information selection unit 53 accepts the selection of the execution instruction information 42 in the case when the micro control unit 24 recognizes that the execution instruction information 42 (a visible display button “Yes”) in the image quality comparison display execution menu 41 is selected through the above-described button operation. In this case, the presented information selection unit 53 makes the image quality setting unit 55, the image composition unit 54, and the display device 21 execute the processing for realizing the image quality comparison display via the micro control unit 24.

Further, as shown in FIG. 2, FIG. 6, the information presenting unit 52 and the presented information selection unit 53 can recognize that a function selection menu 45, an image quality comparison function setting menu 46, a comparison screen number setting menu 47, a comparison image type setting menu 48, and an OSD (On Screen Display) display setting menu 49 are selected through the above-described button operation. Further, in the case when accepting the presenting requests of these selected menus via the micro control unit 24, the information presenting unit 52 and the presented information selection unit 53, as shown in FIG. 6, display each of the above-described menus on the display device 21.

Further, as shown in FIG. 2, FIG. 6, the image composition unit 54 has an image arrangement number setting section 54a. The image arrangement number setting section 54a corresponds to one of visible display buttons “2 to 6” in the comparison screen number setting menu 47 being selected, and allows number of the image quality comparison image on the composite image 40 to be changed to any of 2 to 6.

Further, the image composition unit 54 has an OSD screen composition section 54b. This OSD screen composition section 54b corresponds to “an image quality mode name” in the OSD display setting menu 49 being selected, and overlaps information 37 indicating the image quality of the image quality comparison image (the image quality modes A to F) on the corresponding image quality comparison image thereby generating the composite image 40.

Further, the OSD screen composition section 54b corresponds to “a source name” in the OSD display setting menu 49 being selected, and overlaps information specifying the source (a, b, c . . . ) of the image input in the image input unit 51 on the image quality comparison images (31 to 36) thereby generating the composite image 40.

Further, as shown in FIG. 2, FIG. 5, the comparison image selection unit 56 is to select one of the plural image quality comparison images 31 to 36 on the composite image 40 displayed on the display device 21 through, for example, a predetermined button operation from the remote controller 26. In this case, the display device 21, as shown in FIG. 5, displays the image quality comparison image selected in the comparison image selection unit 56 thereon with emphasis. That is, the display device 21 performs a highlight display 32a increasing luminance at an edge portion of the selected image quality comparison image.

Further, as shown in FIG. 2, the selection decision unit 58 is to decide the selection of one of the image quality comparison images performed in the comparison image selection unit 56 through, for example, a predetermined button operation by the remote controller 26, or the like. Here, the image composition unit 54 has a full screen switching section 54c. The full screen switching section 54c controls the display device 21 to display the image quality comparison image decided in the selection decision unit 58 in full size of the display device 21. That is, the full screen switching section 54c performs a full screen display of the selected image quality comparison image. Accordingly, the image quality of the selected image quality comparison image can be recognized visually in details on a user side.

Further, as shown in FIG. 2, the selection state detection unit 57 detects a selection state of the image quality comparison image performed in the comparison image selection unit 56. Further, the display device 21 has a timer 57a, and controls a state of highlight (the highlight display) on the image quality comparison image based on a detection result performed in the selection state detection unit 57. Concretely, the display device 21 changes the highlight display in the case when detecting that the position of the highlight display does not shift for, for example, a predetermined time or more through the timer 57a (the case when the image quality comparison image being selected is the same for a predetermined time or more). That is, in this case, the display device 21 makes the highlight display disappear from the screen automatically, or changes the highlight display to luminance, which is an inconspicuous degree. Further, thereafter, in the case of another image quality comparison image being selected, the display device 21 returns the highlight display to the selected another image quality comparison image at initial luminance.

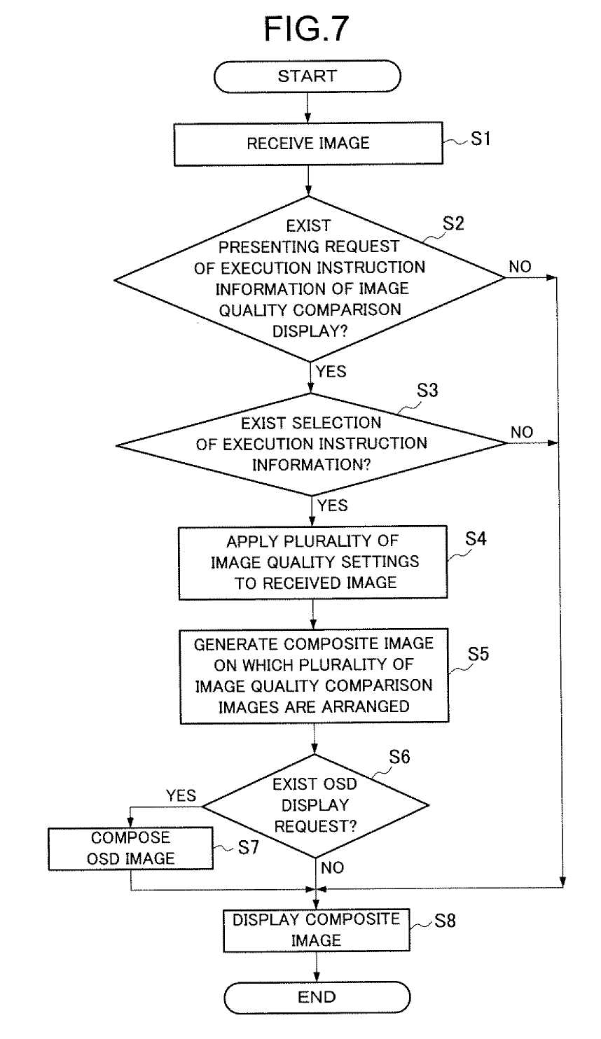

Next, there will be explained the processing for realizing the image quality comparison display performed in this image display device 20 based on the flowchart shown in FIG. 7. As shown in FIG. 7, firstly, the image input unit 51 receives an image output from the video decoder 17 (S1). Next, the information presenting unit 52 detects whether or not the presenting request of the image quality comparison display execution menu 41 including the execution instruction information 42 exists (S2). As shown in FIG. 4, in the case when this presenting request exists (YES at S2), and further, the presented execution instruction information 42 is selected (YES at S3), the image quality setting unit 55 applies the image quality modes A to F different from one another to the image received by the image input unit 51 thereby obtaining a plurality of images whose image quality is different (S4).

Subsequently, the image composition unit 54 generates the composite image 40 on which the plural images whose image quality is different obtained in the image quality setting unit 55 are arranged as the image quality comparison images 31 to 36 of, for example, six kinds (S5). Next, in the case when the OSD screen composition section 54b detects whether or not a display request of an OSD display exists (S6), and the OSD display is required (YES at S6), the OSD screen composition section 54b composes the image quality mode name and the source name on the composition image 40 (S7).

Next, as shown in FIG. 5, the display device 21 displays the composite image (multi-screen) 40 on which the six image quality comparison images 31 to 36 where the image quality modes A to F are set individually are arranged as the sub-screen thereon (S8).

As described above, the television receiving apparatus 10 provided with the image display device 20 according to this embodiment is to display the six image quality comparison images 31 to 36 having the different image quality modes A to F obtained from the same image thereon in an arranged manner. Therefore, the television receiving apparatus 10 makes it easy to recognize differences of the settable image quality visually, and makes it possible to discern superiority or inferiority of the image quality setting to the image easily. Accordingly, the television receiving apparatus 10 allows a user to select the desired image quality setting easily.

As described hereinabove, the present invention has been concretely explained on the basis of the embodiment, but, the present invention is not limited to this embodiment and various modifications can be made without departing from the scope of the invention. That is, the above-described embodiment shows the example where the still image is applied as the image quality comparison images 31 to 36. However, an embodiment of the present invention is not limited to this, and it can be such that a moving image is designated from the comparison image type setting menu 48 shown in FIG. 6, and the moving image is applied as the image quality comparison image.

What is claimed is:

1. An image display device, comprising:
an image input unit configured to receive an image;
an image quality setting unit configured to apply a plurality of image quality settings different from one another to the image received by the image input unit for obtaining a plurality of images whose image quality is different;
an image composition unit configured to generate a composite image including the plural images whose image quality is different obtained in the image quality setting unit arranged as a plurality of image quality comparison images; and
an image display unit configured to display the composite image generated in the image composition unit thereon.

2. The image display device of claim 1, further comprising:
an information presenting unit configured to control the image display unit to display execution instruction information for executing each of an application of the plural image quality settings performed in the image quality setting unit, a generation of the composite image performed in the image composition unit, and a display of the composite image performed at the image display unit in a selectable manner; and
a presented information selection unit configured to select the execution instruction information displayed by the image display unit.

3. The image display device of claim 1, further comprising,
a still image extraction section configured to extract one scene from the image received by the image input unit as a still image, when the image received by the image input unit is a moving image,
wherein the image quality setting unit applies the plural image quality settings different from one another to the still image extracted in the still image extraction section to obtain a plurality of still images whose image quality is different.

4. The image display device of claim 1,
wherein the image composition unit comprises an image arrangement number setting section to change number of the image quality comparison image.

5. The image display device of claim 1,
wherein the image composition unit overlaps information indicating image quality of the image quality comparison image on the corresponding image quality comparison image to generate the composite image.

6. The image display device of claim 1,
wherein the image composition unit overlaps information specifying a source of the image input in the image input unit on the image quality comparison image thereby generating the composite image.

7. The image display device of claim 1, further comprising,
a comparison image selection unit configured to select one of the plural image quality comparison images on the composite image displayed in the image display unit,
wherein the image display unit displays the image quality comparison image selected in the comparison image selection unit thereon with emphasis.

8. The image display device of claim 7, further comprising:
a selection decision unit configured to decide a selection of one of the image quality comparison images performed in the comparison image selection unit; and
a full screen switching section configured to control the image display unit to display the image quality comparison image decided in the selection decision unit in full size of the image display unit.

9. The image display device of claim 7, further comprising,
a selection state detection unit configured to detect a selection state of the image quality comparison image performed in the comparison image selection unit,
wherein the image display unit controls a highlight display state on the image quality comparison image based on a detection result performed in the selection state detection unit.

10. An image display method, comprising:
receiving an image;
applying a plurality of image quality settings different from one another to the received image for obtaining a plurality of images whose image quality is different;
generating a composite image including the plural images whose image quality is different are arranged as a plurality of image quality comparison images; and
displaying the generated composite image.
